(19) United States
(12) Patent Application Publication
(10) Pub. No.: US 2019/0193122 A1
(43) Pub. Date: Jun. 27, 2019

(54) ENDOSCOPE SYSTEM FOR CLEANING

(71) Applicant: Zhigang Liu, Shenzhen, Guangdong (CN)

(72) Inventor: Zhigang Liu, Shenzhen, Guangdong (CN)

(21) Appl. No.: 16/313,143

(22) PCT Filed: Jun. 15, 2017
(86) PCT No.: PCT/CN2017/088398

§ 371 Date: Dec. 25, 2018

(30) Foreign Application Priority Data
Jul. 7, 2016 (CN) 201610531880.4

(51) Int. Cl. B08B 3/02; B08B 3/04; B08B 9/00; G02B 23/24

(52) U.S. Cl. CPC B08B 3/026; B08B 3/04; G02B 23/2461; G02B 23/2476; G02B 23/2423; B08B 9/00

(57) ABSTRACT

An endoscope system for cleaning includes a hand-held endoscope and a console including an air pump and an air inlet pathway, a liquid storage bottle, a liquid inlet pathway, a three-way connecting member and an air-liquid pathway. The three-way connecting member is respectively connected to the air inlet pathway, the liquid inlet pathway and the air-liquid pathway. One end of the air inlet pathway remote from the three-way connecting member is connected to the air pump; one end of the liquid inlet pathway remote from the three-way connecting member is connected to the liquid storage bottle, and the liquid inlet pathway is provided with a liquid inlet pump. The hand-held endoscope is provided with a camera and a cleaning nozzle, and the hand-held endoscope and the air-liquid pathway is communicated with each other through a liquid guiding hose, and the cleaning nozzle is communicated with the liquid guiding hose.

### TECHNICAL FIELD

The disclosure belongs to the technical field of industrial endoscopes, and in particular relates to an endoscope system for cleaning.

### BACKGROUND

The endoscope is a hose electronic device equipped with a camera for transmitting images that are difficult for human eyes to directly observe to the display screen. It is not only used in the medical field, but also used in industrial fields, such as device inspection, metal flaw detection, and so on.

In order to perform cleaning, painting and the like on a specific area, an existing type of endoscope can perform cleaning or painting by providing a cleaning tube and a liquid storage bottle to spray a specific area. However, the existing endoscope device for cleaning has the following deficiencies:

1. There are many additional devices for the endoscope body, such as the liquid storage device, which affects the operator's manipulation of the endoscope body and is not conducive to its manipulation;

2. The flow rate of the cleaning fluid produced by the endoscope device is not well controlled and the pressure is low, thereby affecting the cleaning effect, while simply increasing the liquid pressure causes waste of the cleaning fluid.

### SUMMARY

In view of the problem that the existing endoscope cleaning device has insufficient maneuverability and poor adjustability, the present disclosure provides an endoscope system for cleaning.

The technical solution adopted by the present disclosure to solve the above technical problems is as follows:

an endoscope system for cleaning is provided, including: a hand-held endoscope and a console. The console is provided with an air pump, an air inlet pathway, a liquid storage bottle, a liquid inlet pathway, a three-way connecting member and an air-liquid pathway. The three-way connecting member is respectively connected to the air inlet pathway, the liquid inlet pathway and the air-liquid pathway. An end of the air inlet pathway which is remote from the three-way connecting member is connected to the air pump; an end of the liquid inlet pathway which is remote from the three-way connector is connected to the liquid storage bottle; and the liquid inlet pathway is provided with a liquid inlet pump. The hand-held endoscope is provided with a camera and a cleaning nozzle, the hand-held endoscope and the air-liquid pathway are communicated with each other through a liquid guiding hose, and the cleaning nozzle is communicated with the liquid guiding hose.

Furthermore, the console is further provided with an air charging pathway, one end of the air charging pathway is communicated with the air inlet pathway, and the other end of the air charging pathway is located outside the console and is connected with an air charging joint.

Furthermore, the console is further provided with a liquid inlet pump switch for controlling the liquid inlet pump, an air pump switch for controlling the air pump, and a pressure gauge for monitoring an air pressure of the air pump.

Furthermore, the air charging pathway is provided with an air charging valve, the air inlet pathway is provided with an air inlet valve, the liquid inlet pathway is provided with a liquid inlet valve, the air-liquid pathway is provided with an air-liquid valve, and the console is correspondingly provided with an air charging valve switch for controlling opening and closing of the air charging valve, an air inlet valve switch for controlling opening and closing of the air inlet valve, and a liquid inlet valve switch for controlling opening and closing of the liquid inlet valve, an air-liquid valve switch.

Furthermore, the console is further provided with a battery pack for power supply, a power control module, and a power switch for controlling the power control module, the battery pack is electrically connected to the power control module, and the power control module is provided with a power line, one end of the power line is connected to the power control module, and the other end of the power line extends to an outside of the console and is connected with a power plug.

Furthermore, the hand-held endoscope is electrically connected to the console through a power supply line, one end of the power supply line is connected to the hand-held endoscope, and the other end of the power supply line is detachably connected to the power control module.

Furthermore, the hand-held endoscope includes a flexible tube, a hand-held end and a receiving end. The flexible tube includes a head end and a tail end, and the camera and the cleaning nozzle are disposed at the head end of the flexible tube, and the flexible tube is internally provided with a liquid tube for inputting liquid and a signal transmission line for signal transmission, the signal transmission line is electrically connected to the camera, and one end of the liquid tube is communicated with the cleaning nozzle, and the other end of the liquid tube is communicated with the liquid guiding hose; the tail end of the flexible tube is connected to the hand-held end through the liquid tube and the signal transmission line therein; the hand-held end is in wired or wireless communication with the receiving end.

Furthermore, the air-liquid pathway is provided with an air-liquid valve, and the hand-held end is provided with an air-liquid valve switch by which opening and closing of the air-liquid valve is controlled.

Furthermore, a plurality of LED lamps are disposed on an outer circumference of the camera, the LED lamps is connected to the signal transmission line inside the flexible tube, and the hand-held end is provided with an LED control button.

Furthermore, the hand-held end is provided with a communication module for exchanging signals with the camera and the receiving end, respectively; the communication module includes a wired communication module and a wireless communication module; the hand-held end is provided with a clamping seat, and the receiving end is provided with a clamping groove, the clamping seat is electrically connected to the wired communication module, and the clamping groove is electrically connected to the receiving end. When the receiving end is connected to the clamping groove of the hand-held end through the clamping seat, the receiving end and the hand-held end are in wired communication. When the receiving end is separated from the hand-held end, the receiving end and the hand-held end are in wireless communication, and the wireless communication module is provided with a transmitting frequency band switch, the receiving end is provided with a receiving frequency band switch.

According to the endoscope system for cleaning provided by the present disclosure, the air pump, the air inlet pathway, the liquid storage bottle, the liquid inlet pathway, and so on, are collectively integrated through the console, thereby separating the hand-held endoscope from the console in order to reduce the weight of the hand-held endoscope, and improving the operability of the endoscope system by controlling the operation of ventilation and liquid instillation through the console. In the console, the first-level pressurization by the liquid inlet pump is performed to pump the liquid in the liquid storage bottle into the liquid inlet pathway, and the end of the liquid inlet pathway is connected to the air inlet pathway, and the high pressure air is applied through the air inlet pathway to perform second-level pressurization on the cleaning liquid, so that the cleaning liquid is sprayed under high pressure, thereby facilitating to improve the cleaning effect of the cleaning liquid.

### BRIEF DESCRIPTION OF THE DRAWINGS

FIG. 1 is a schematic structural view of an endoscope system for cleaning according to an embodiment of the present disclosure;

FIG. 2 is a simplified structural view of an endoscope system for cleaning according to an embodiment of the present disclosure;

FIG. 3 is a schematic structural view of a hand-held endoscope of an endoscope system for cleaning according to an embodiment of the present disclosure;

FIG. 4 is a schematic view of an end face of a flexible tube of an endoscope system for cleaning according to an embodiment of the present disclosure;

FIG. 5 is a schematic structural view of a hand-held end of an endoscope system for cleaning according to an embodiment of the present disclosure;

FIG. 6 is a schematic structural view of a receiving end of an endoscope system for cleaning according to an embodiment of the present disclosure;

FIG. 7 is a front view showing the receiving end of the endoscope system for cleaning according to an embodiment of the present disclosure.

The reference numerals in the drawings are as follows: 1, hand-held endoscope; 11, liquid guiding hose; 12, power supply line; 13, flexible tube; 131, liquid tube; 132, tube joint; 133, signal transmission line; 134, video signal connector; 135, camera; 136, LED lamp; 137, cleaning nozzle; 14, hand-held end; 141, tube connecting seat; 142, video signal connecting seat; 143, LED control button; 144, clamping seat; 145, transmitting frequency band switch; 146, air-liquid valve switch; 15, receiving end; 151, clamping groove; 152, receiving frequency band switch; 153, display screen; 154, function button; 155, receiving end switch button; 2, console; 21, pressure gauge; 23 power switch; 23, air charging valve switch; 24, air pump switch; 25, air inlet valve switch; 26, air inlet pump switch; 27, liquid inlet valve switch; 28, battery pack; 29, power control module; 291, power line; 292, power plug; 3, air pump; 4, air inlet pathway; 41, air inlet valve; 42, three-way tube; 5, liquid storage bottle; 6, liquid inlet pathway; 61, liquid inlet pump; 62, liquid inlet valve; 7, three-way connecting member; 8, air-liquid pathway; 81, air-liquid valve; 9, air charging pathway; 91, air charging valve; 92, air charging joint.

### DETAILED DESCRIPTION

The present disclosure will be further described in detail below with reference to the accompanying drawings and embodiments. It is understood that the specific embodiments described herein are merely illustrative of the disclosure and are not intended to limit the disclosure.

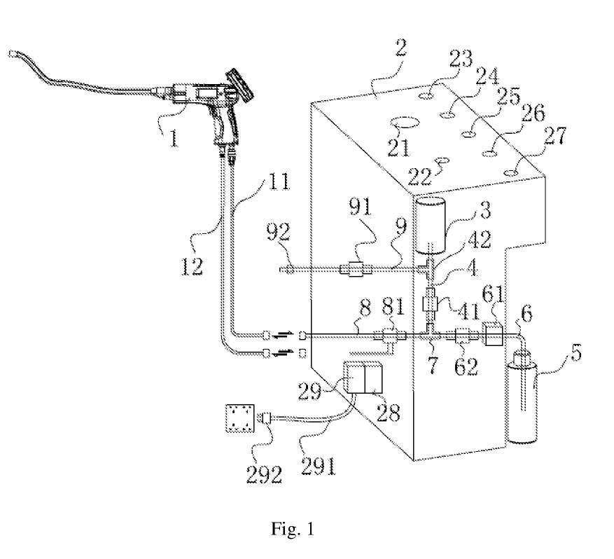

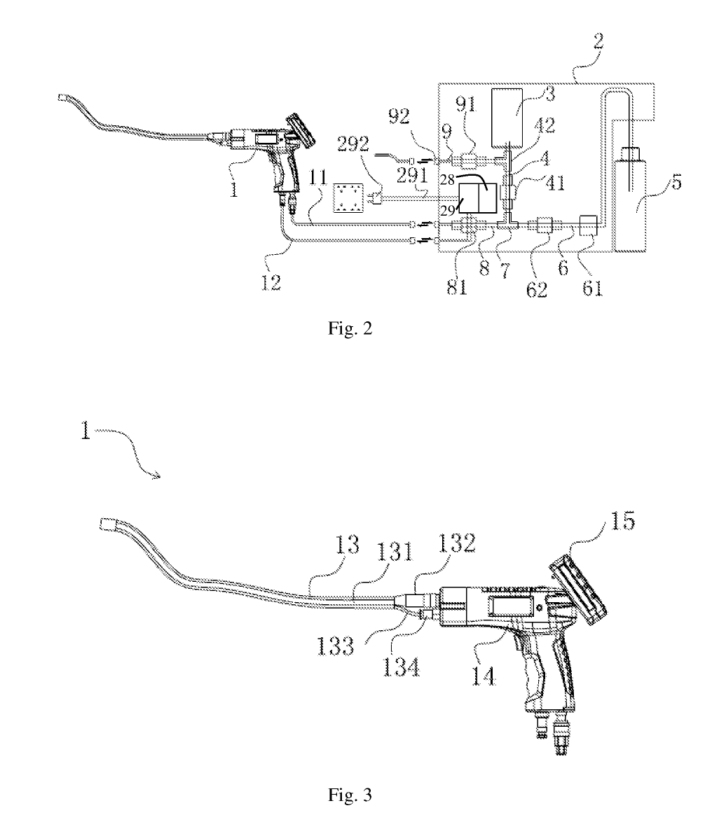

Referring to FIG. 1 and FIG. 2, the embodiment discloses an endoscope system for cleaning, including a hand-held endoscope 1 and a console 2. The console 2 is provided with an air pump 3, an air inlet pathway 4, a liquid storage bottle 5, a liquid inlet pathway 6, a three-way connecting member 7, and an air-liquid pathway 8. The three-way connecting member 7 is respectively connected to the air inlet pathway 4, the liquid inlet pathway 6 and the air-liquid pathway 8. An end of the air inlet pathway 4 which is remote from the three-way connecting member 7 is connected to the air pump 3 by which the air is compressed and pressurized. The pressurized high pressure air enters the three-way connecting member 7 through the air inlet pathway 4. An end of the liquid inlet pathway 6 which is remote from the three-way connecting member 7 is connected to the liquid storage bottle 5. The liquid inlet pathway 6 is provided with a liquid inlet pump 61 by which the cleaning liquid in the liquid storage bottle 5 is pumped out for first-level pressurization. The pressurized cleaning liquid enters the three-way connecting member 7 through the liquid inlet pathway 6. The high pressure air performs second-level pressurization on the cleaning liquid at the three-way connecting member 7, and simultaneously atomizes the cleaning liquid such that the cleaning liquid can be sprayed evenly and with a certain impact pressure to the position needed to be cleaned, thereby improving the cleaning effect of the cleaning liquid and reducing the usage of cleaning liquid.

The hand-held endoscope 1 is provided with a camera 135 and a cleaning nozzle 137. The hand-held endoscope 1 and the air-liquid pathway 8 are connected to each other by providing a liquid guiding hose 11, and the cleaning nozzle 137 is communicated with the liquid guiding hose 11. It should be noted that the communication between the cleaning nozzle 137 and the liquid guiding hose 11 may be a direct connection or an indirect connection, wherein the indirect connection refers to guiding the liquid guiding hose 11 to the cleaning nozzle 137 by providing an additional tube. The hand-held endoscope 1 is separated from the console 2 to reduce the weight of the hand-held endoscope 1, and the operability of the endoscope system is improved by controlling the operation of ventilation and liquid instillation through the console 2.

In the embodiment, the console 2 is further provided with an air charging pathway 9, an end of the air charging pathway 9 is communicated with the air inlet pathway 4, and the air inlet pathway 4 is provided with a three-way tube 42. The three-way tube 42 is connected to both ends of the air inlet pathway 4 and the air charging pathway 9, respectively, and the other end of the air charging pathway 9 is located outside the console 2 and is connected with an air charging joint 92. The air charging joint 92 is used to inflate the external device, such as tires, basketball, swimming rings, and so on. On the other hand, by setting the air charging pathway 9, the air pressure of the air inlet pathway 4 can be diverted when necessary, thereby achieving the pressure control of the second-level pressurization of the cleaning liquid. The air inlet pathway 4 can also be supplied with air through an external air tube connecting with the air charging joint 92.

In the present embodiment, the console 2 is a box structure, and the air pump 3, the air inlet pathway 4, the liquid inlet pathway 6, the three-way connecting member 7 and the air-liquid pathway 8 are located inside the console 2. The liquid storage bottle 5 is located outside the console 2 to facilitate replacement of the liquid storage bottle 5. The liquid storage bottle 5 can store a functional liquid such as a cleaning liquid, a paint or a disinfectant.

The console 2 is provided with a liquid inlet pump switch 26 for controlling the liquid inlet pump 61, an air pump switch 24 for controlling the air pump 3, and a pressure gauge 21 for monitoring the air pressure of the air pump 3. The air pump switch 24 and the pressure gauge 21 are provided on the top surface of the console 2.

The air charging pathway 9 is provided with an air charging valve 91. The air inlet pathway 4 is provided with an air inlet valve 41. The liquid inlet pathway 6 is provided with a liquid inlet valve 62. The console 2 is correspondingly provided with an air charging valve switch 23 for controlling opening and closing of the air charging valve 91, an air inlet valve switch 25 for controlling opening and closing of the air inlet valve 41, and a liquid inlet valve switch 27 for controlling opening and closing of the liquid inlet valve 62. The air charging valve switch 23, the air inlet valve switch 25 and the liquid inlet valve switch 27 are provided on the top surface of the console 2.

The console 2 is further provided with a battery pack 28 for power supply, a power control module 29, and a power switch 22 for controlling the power control module 29. The battery pack 28 and the power control module 29 are electrically connected with each other. The power control module 29 is provided with a power line 291. One end of the power line 291 is connected to the power control module 29, and the other end extends to the outside of the console 2 and is connected with a power plug 292. The power plug 292 is connected to an external power socket to supply power to the console 2 to drive the air pump 3, the liquid inlet pump 61 and various types of valves in the console 2 to operate. The air charging valve 91, the air inlet valve 41, and the liquid inlet valve 62 and the air-liquid valve 81 are preferably solenoid valves.

The hand-held endoscope 1 is electrically connected to the console 2 by providing a power supply line 12. Specifically, one end of the power supply line 12 is connected to the hand-held endoscope 1, and the other end is detachably connected to the power control module 29. One end of the liquid guiding hose 11 is connected to the hand-held endoscope 1 and the other end is detachably connected to the air-liquid pathway 8. That is, the hand-held endoscope 1 is detachably connected to the console 2.

As shown in FIG. 3, the hand-held endoscope 1 includes a flexible tube 13, a hand-held end 14 and a receiving end 15.

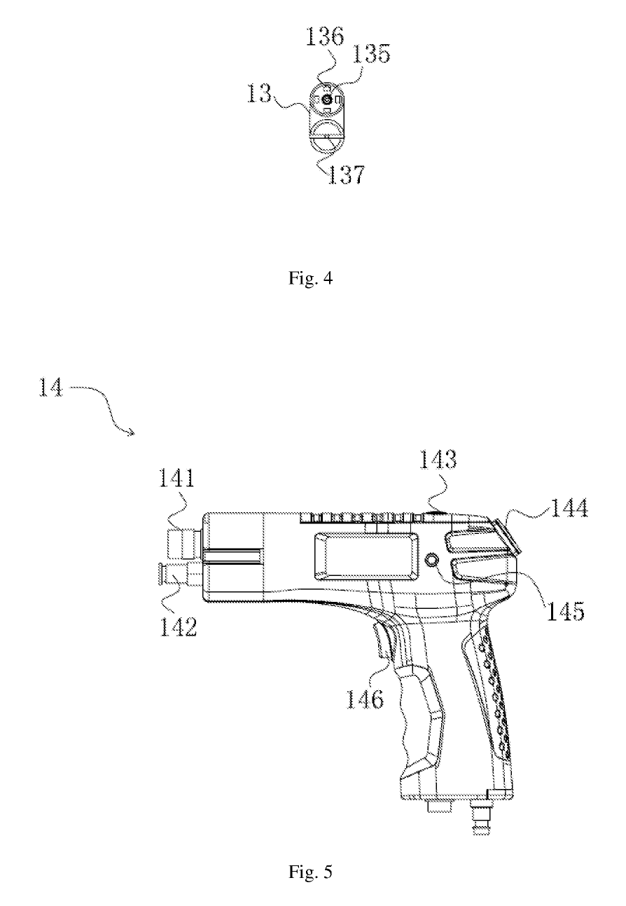

The flexible tube 13 has a head end and a tail end. As shown in FIG. 4, the camera 135 and the cleaning nozzle 137 are disposed at the head end of the flexible tube 13, and the flexible tube 13 is internally provided with a liquid tube 131 for inputting liquid and a signal transmission line 133 for signal transmission. The signal transmission line 133 is electrically connected to the camera 135, and the liquid tube 131 is communicated with the cleaning nozzle 137.

The tail end of the flexible tube 13 is connected to the hand-held end 14 through the liquid tube 131 and the signal transmission line 133 therein. Specifically, most of the liquid tube 131 and the signal transmission line 133 are wrapped in the flexible tube 13. The liquid tube 131 and the signal transmission line 133 at the tail end of the flexible tube 13 are branched to extend out to form an independent liquid tube 131 and an independent signal transmission line 133 which are connected to the hand-held end 14. The hand-held end 14 is connected to the receiving end 15 by wire or wirelessly, and the camera 135 collects the video image of the flexible tube 13 in its operating space and transmits the video image to the hand-held end 14 via the signal transmission line 133, and then transcodes and transmits the video image to the receiving end 15 via the hand-held end 14. The receiving end 15 is provided with a display screen 153. The display screen 153 displays the video image, so that the operator can understand the image condition of the inspection position of the device, thereby determining whether dirt, clogging, or falling of the paint film occurs. After the problem is determined, the cleaning nozzle 137 on the head end of the flexible tube 13 may perform dirt removal, lacquering, and the like.

The air-liquid pathway 8 is provided with an air-liquid valve 81, and the hand-held end 14 is provided with an air-liquid valve switch 146, and the air-liquid valve switch 146 is electrically connected to the air-liquid valve 81 through the power supply line 12. The opening and closing of the air-liquid valve 81 is controlled by the air-liquid valve switch 146.

When a separate liquid flushing is performed, the liquid inlet valve 62 is controlled to be opened by the liquid inlet valve switch 27 on the console 2, while the liquid inlet pump 61 is controlled to operate by the liquid inlet pump switch 26, and then by pressing the air-liquid valve switch 146, the air-liquid valve 81 is controlled to be opened or closed, and the liquid inlet pump 61 extracts the cleaning liquid in the liquid storage bottle 5 for liquid cleaning operation.

When a separate air flushing is performed, the air pump 3 is controlled to operate by the air pump switch 24 on the console 2, while the air inlet valve 41 is controlled to be opened by the air inlet valve switch 25, and then by pressing the air-liquid valve switch 146, the air-liquid valve 81 is controlled to be opened or closed, and the air pump 3 produces high pressure air and purging is performed by using air through the cleaning nozzle 137.

When the liquid atomization cleaning is performed, the liquid inlet valve 62 is controlled to be opened by the liquid inlet valve switch 27 on the console 2, and the liquid inlet pump 61 is controlled to operate by the liquid inlet pump switch 26, the air pump 3 is controlled to operate by the air pump switch 24 on the console 2, and at the same time the air inlet valve 41 is controlled to be opened by the air inlet valve switch 25, and then the air-liquid valve 81 is controlled to be opened or closed by pressing the air-liquid valve switch 146. The cleaning liquid in the liquid storage bottle 5 is extracted by the liquid inlet pump 61 for first-level pressurization, and the air pump 3 produces high pressure air to perform second-level pressurization on the cleaning liquid to realize a mixed cleaning function of air and liquid.

With the above arrangement, the states of the liquid inlet valve 62, the liquid inlet pump 61, the air inlet valve 41, and the air pump 3 can be set before the cleaning or purging operation, and the subsequent cleaning or purging operation is performed only by pressing the air-liquid valve switch 146 to realize the discharge and closing of the cleaning liquid and the air. The operation is convenient and quick, and the operability of the endoscope system is effectively improved.

A plurality of LED lamps 136 are disposed on an outer circumference of the camera 135. The LED lamps 136 are connected to the signal transmission line 133 inside the flexible tube 13, and the LED lamps 136 provide light illumination to meet image acquisition requirements in certain weak light position. The hand-held end 14 is provided with an LED control button 143 by which opening and closing of the LED lamps 136 are controlled at the position of the camera 135.

As shown in FIG. 5, the hand-held end 14 includes an external hand-held housing, and inside the hand-held end 14, a communication module (not shown in the figure) is provided for exchanging signals with the camera 135 and the receiving end 15, respectively. The communication module includes a wired communication module and a wireless communication module.

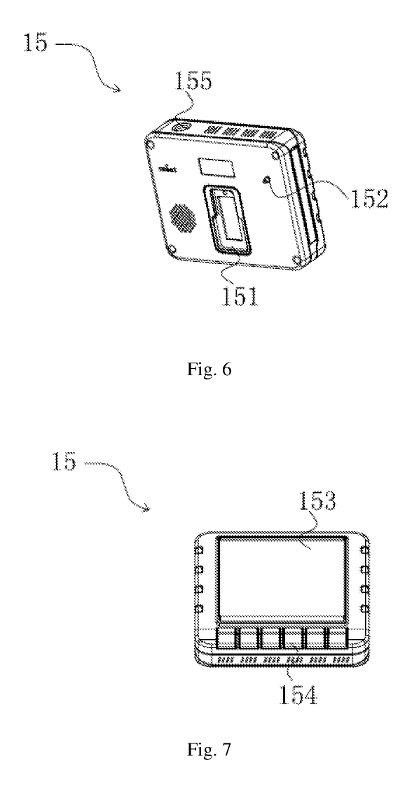

As shown in FIG. 5 to FIG. 7, the receiving end 15 and the hand-held end 14 are detachably connected. The hand-held end 14 is provided with a clamping seat 144, and the receiving end 15 is provided with a clamping groove 151. The clamping seat 144 is electrically connected to the wired communication module, and the clamping groove 151 is electrically connected to the receiving end 15. The receiving end 15 and the hand-held end 14 can be connected through the clamping groove 151 and the clamping seat 144. When the receiving end 15 is connected to the clamping groove 151 of the hand-held end 14 through the clamping seat 144, the receiving end 15 and the hand-held end 14 are electrically connected by wire to implement wired transmission, and information transmission is performed between the wired communication module in the hand-held end 14 and the receiving end 15. The receiving end 15 is provided with a display screen 153, a function button 154, and a receiving end switch button 155.

When the receiving end 15 and the hand-held end 14 are separated, the communication mode between the receiving end 15 and the hand-held end 14 is automatically converted into wireless communication, and information transmission is performed between the wireless communication module in the hand-held end 14 and the receiving end 15. Those skilled in the art may adopt Bluetooth, GPRS, WIFI and other communication modes as needed. Wireless communication realizes the separation of the receiving end 15 and the hand-held end 14 within a certain range, thereby reducing the restriction on the operation of the flexible tube 13. The operator can monitor the operating environment of the flexible tube 13 at any position. The wireless communication module is provided with a transmitting frequency band switch 145 by which the signal transmission channel of the video information transmitted by the wireless communication module is changed, and the receiving end 15 is provided with a receiving frequency band switch 152 by which the signal transmission channel of the receiving end 15 for receiving video information is changed. When the wireless communication module and the receiving end 15 are in the same signal transmission channel, the signal transmission can be performed. When multiple endoscope devices work simultaneously in the same working environment, multiple signal transmission channels can be set such that different endoscope devices are in different signal transmission channels to avoid signal interference between different endoscope devices.

The end of the signal transmission line 133 at the tail end of the flexible tube 13 is provided with a video signal connector 134; the end of the liquid tube 131 at the tail end of the flexible tube 13 is provided with a tube joint 132, and the hand-held end 14 is provided with a video signal connecting seat 142 and a tube connecting seat 141. The video signal connecting seat 142 is electrically connected to the video signal connector 134; the tube connecting seat 141 is connected to the tube joint 132 and is an internal conductive mechanical connection, including a screw connection, a snap connection, and the like.

The hand-held end 14 is internally provided with a connecting tube (not shown in the figure), which is connected to the liquid tube 131 and the liquid guiding hose 11, respectively.

The above is only the preferred embodiment of the present disclosure, and is not intended to limit the present disclosure. Any modifications, equivalent substitutions and improvements made within the spirit and principles of the present disclosure should be included within the protection scope of the present disclosure.

1. An endoscope system for cleaning, comprising: a hand-held endoscope (1) and a console (2);
wherein the console (2) is provided with an air pump (3), an air inlet pathway (4), a liquid storage bottle (5), a liquid inlet pathway (6), a three-way connecting member (7) and an air-liquid pathway (8);
wherein the three-way connecting member (7) is respectively connected to the air inlet pathway (4), the liquid inlet pathway (6) and the air-liquid pathway (8);
an end of the air inlet pathway (4) which is remote from the three-way connecting member (7) is connected to the air pump (3);
an end of the liquid inlet pathway (6) which is remote from the three-way connector (7) is connected to the liquid storage bottle (5), and the liquid inlet pathway (6) is provided with a liquid inlet pump (61);
the hand-held endoscope (1) is provided with a camera (135) and a cleaning nozzle (137), the hand-held endoscope (1) and the air-liquid pathway (8) are communicated with each other through a liquid guiding hose (11), and the cleaning nozzle (137) is communicated with the liquid guiding hose (11).

2. The endoscope system for cleaning according to claim 1, wherein the console (2) is further provided with an air charging pathway (9), one end of the air charging pathway (9) is communicated with the air inlet pathway (4), and an other end of the air charging pathway (9) is located outside the console (2) and is connected with an air charging joint (92).

3. The endoscope system for cleaning according to claim 1 or 2, wherein the console (2) is further provided with a liquid inlet pump switch (26) for controlling the liquid inlet pump (61), an air pump switch (24) for controlling the air pump (3), and a pressure gauge (21) for monitoring an air pressure of the air pump (3).

4. The endoscope system for cleaning according to claim 2, wherein the air charging pathway (9) is provided with an air charging valve (91), the air inlet pathway (4) is provided with an air inlet valve (41), the liquid inlet pathway (6) is provided with a liquid inlet valve (62), and the console (2) is correspondingly provided with an air charging valve switch (23) for controlling opening and closing of the air charging valve (91), an air inlet valve switch (25) for controlling opening and closing of the air inlet valve (41), and a liquid inlet valve switch (27) for controlling opening and closing of the liquid inlet valve (62).

5. The endoscope system for cleaning according to claim 1, wherein the console (2) is further provided with a battery pack (28) for power supply, a power control module (29), and a power switch (22) for controlling the power control module (29), the battery pack (28) is electrically connected to the power control module (29), and the power control module (29) is provided with a power line (291), one end of the power line (291) is connected to the power control module (29), and an other end of the power line (291) extends to an outside of the console (2) and is connected with a power plug (292).

6. The endoscope system for cleaning according to claim 5, wherein the hand-held endoscope (1) is electrically connected to the console (2) through a power supply line (12), one end of the power supply line (12) is connected to the hand-held endoscope (1), and an other end of the power supply line (12) is detachably connected to the power control module (29).

7. The endoscope system for cleaning according to claim 1, wherein the hand-held endoscope (1) comprises a flexible tube (13), a hand-held end (14) and a receiving end (15);
the flexible tube (13) comprises a head end and a tail end, and the camera (135) and the cleaning nozzle (137) are disposed at the head end of the flexible tube (13), and the flexible tube (13) is internally provided with a liquid tube (131) for inputting liquid and a signal transmission line (133) for signal transmission, the signal transmission line (133) is electrically connected to the camera (135), and one end of the liquid tube (131) is communicated with the cleaning nozzle (137), and an other end of the liquid tube (131) is communicated with the liquid guiding hose (11);
the tail end of the flexible tube (13) is connected to the hand-held end (14) through the liquid tube (131) and the signal transmission line (133) therein; the hand-held end (14) is in wired or wireless communication with the receiving end (15).

8. The endoscope system for cleaning according to claim 7, wherein the air-liquid pathway (8) is provided with an air-liquid valve (81), and the hand-held end (14) is provided with an air-liquid valve switch (146) by which opening and closing of the air-liquid valve (81) is controlled.

9. The endoscope system for cleaning according to claim 7, wherein a plurality of LED lamps (136) are disposed on an outer circumference of the camera (135), the LED lamps (136) is connected to the signal transmission line (133) inside the flexible tube (13), and the hand-held end (14) is provided with an LED control button (143).

10. The endoscope system for cleaning according to claim 7, wherein the hand-held end (14) is provided with a communication module for exchanging signals with the camera (135) and the receiving end (15), respectively; the communication module comprises a wired communication module and a wireless communication module; the hand-held end (14) is provided with a clamping seat (144), and the receiving end (15) is provided with a clamping groove (151), the clamping seat (144) is electrically connected to the wired communication module, and the clamping groove (151) is electrically connected to the receiving end (15);
when the receiving end (15) is connected to the clamping groove (151) of the hand-held end (14) through the clamping seat (144), the receiving end (15) and the hand-held end (14) are in wired communication;
when the receiving end (15) is separated from the hand-held end (14), the receiving end (15) and the hand-held end (14) are in wireless communication, and the wireless communication module is provided with a transmitting frequency band switch (145), the receiving end (15) is provided with a receiving frequency band switch (152).

11. The endoscope system for cleaning according to claim 2, wherein the console (2) is further provided with a liquid inlet pump switch (26) for controlling the liquid inlet pump (61), an air pump switch (24) for controlling the air pump (3), and a pressure gauge (21) for monitoring an air pressure of the air pump (3).
